(19) United States
(12) Patent Application Publication
(10) Pub. No.: US 2014/0136984 A1
(43) Pub. Date: May 15, 2014

(54) Method for Editing Skin of Client and Skin Editor

(71) Applicants: Yanbing Zhang, Shenzhen (CN); Qiang Tu, Shenzhen (CN); Ni Wang, Shenzhen (CN); Xin Xie, Shenzhen (CN)

(72) Inventors: Yanbing Zhang, Shenzhen (CN); Qiang Tu, Shenzhen (CN); Ni Wang, Shenzhen (CN); Xin Xie, Shenzhen (CN)

(73) Assignee: TENCENT TECHNOLOGY (SHENZHEN) COMPANY LIMITED, Shenzhen (CN)

(21) Appl. No.: 14/122,223

(22) PCT Filed: Apr. 12, 2012
(86) PCT No.: PCT/CN2012/073891

§ 371 Date: Nov. 25, 2013

(30) Foreign Application Priority Data
May 23, 2011 (CN) 201110133928.3

(51) Int. Cl. G06F 3/0481

(52) U.S. Cl. CPC G06F 3/0481
USPC 715/747

(57) ABSTRACT

Examples of the present disclosure provide a method for editing a client skin and a skin editor. The method may include: displaying a background picture on a displaying area of background picture; generating a client snapshot; when moving the client snapshot on the displaying area of background picture, determining a location of the client snapshot on the displaying area of background picture, intercepting an area picture covered by the client snapshot according to the location; and updating the client skin according to the intercepted area picture. By employing the technical solution of the present disclosure, flexibility of skin change of a client may be improved.

This application claims priority to a Chinese patent application 201110133928.3, titled “method for editing skin of client and skin editor”, which was filed on May 23, 2011. The disclosures of the application No. 201110133928.3 are incorporated here by reference.

### TECHNICAL FIELD

The present disclosure relates to computer technologies and picture processing technologies, and more particularly, to a method for editing a skin of a client and a skin editor.

### BACKGROUND OF THE INVENTION

Developing to nowadays, Instant Messaging (IM) tools have been accepted by the majority of network users. The IM tools have become indispensable software tools for users. An IM tool may implement an instant communication with Point-to-Point (P2P) technologies at Internet, or even group chat of several buddies.

At present, most of IM clients may provide a function of skin change. A user may select a favorite picture to be taken as background of a client, so as to make the user's client more personalized.

There may be two modes for displaying skin at an IM client, that is, tiling and edge padding.

The tiling refers to displaying a picture with an IM client from top to bottom, and from left to right. When size of an IM client is smaller than or equal to a picture size, the edge padding refers to displaying picture contents. When the size of the IM client is larger than the picture size, the edge padding refers to padding each part of the IM client extending the picture with a single color, which is an average color of the picture.

No matter employing the tiling mode or the edge padding mode, when changing a skin, it may start from a top left corner of a picture. Take the picture as a skin of an IM client and display the picture. For example, in the manner of edge padding, when picture size is larger than size of the IM client, it may take a top left part of the picture as the skin of the IM client and display the skin of the IM client. It may not take any part of the picture as the skin of the IM client. As another example, in the manner of tiling mode, a top left corner of a skin of an IM client may be a top left corner of a picture, which may not be any part of the picture.

Thus, it can be seen that existing skin change method is not flexible, which may not take any part of a picture as a skin of an IM client.

In addition to an IM client, an inflexible problem may also exist for another client when changing a skin.

### SUMMARY OF THE INVENTION

In view of above, the present disclosure provides a method for editing a skin of a client and a skin editor, so as to improve flexibility for changing a skin of a client.

Specifically speaking, the technical solution of the present disclosure is as follows.

A method for editing a skin of a client, including:

displaying a background picture on a displaying area of background picture;

generating a client snapshot;

when moving the client snapshot on the displaying area of background picture, determining a location of the client snapshot on the displaying area of background picture, intercepting an area picture covered by the client snapshot according to the location; and

updating the skin of the client according to the intercepted area picture.

A skin editor of a client, including a snapshot generating module, a displaying module, an intercepting module and an updating module; wherein

the snapshot generating module is configured to generate a client snapshot;

the displaying module is configured to display the client snapshot, and display a background picture on a displaying area of background picture;

the intercepting module is configured to determine a location of the client snapshot on the displaying area of background picture, when the client snapshot is moved on the displaying area of background picture, and intercept an area picture covered by the client snapshot, according to the location; and

the updating module is configured to update a skin of the client, according to the intercepted area picture.

Based on above technical solution, it can be seen that in an example of the present disclosure, when moving a client snapshot on a displaying area of background picture, determine a location of the client snapshot on the displaying area of background picture, intercept an area picture covered by the client snapshot according to the location, and update the skin of the client utilizing the area picture intercepted. Thus, any area of a background picture may be taken as a client skin. Subsequently, a client skin may not start from a top left corner of a background picture, and flexibility of skin change of a client may be improved. The technical solution provided by examples of the present disclosure may also be applied to skin change of an IM client and another client.

### BRIEF DESCRIPTIONS OF THE DRAWINGS

FIG. 1 is a flowchart illustrating a method for editing a client skin, in accordance with an example of the present disclosure.

FIG. 2 is a flowchart illustrating a method for previewing a skin, in accordance with an example of the present disclosure.

FIG. 3 is a flowchart illustrating a method for editing a skin in the manner of edge padding, in accordance with an example of the present disclosure.

FIG. 4 is a flowchart illustrating a method for displaying current background picture on a displaying area of background picture in the manner of edge padding, in accordance with an example of the present disclosure.

FIG. 5 is a flowchart illustrating a method for performing a transition process on contents displayed on a displaying area of background picture, in accordance with an example of the present disclosure.

FIG. 6 is a schematic diagram illustrating a transition process performed on contents displayed on a displaying area of background picture, in accordance with an example of the present disclosure.

FIG. 7 is a flowchart illustrating a method for editing a skin in the manner of tiling, in accordance with an example of the present disclosure.

FIG. 8 is a flowchart illustrating a method for displaying current background picture on a displaying area of background picture in the manner of tiling, in accordance with an example of the present disclosure.

FIG. 9 is a flowchart illustrating a method for intercepting an area picture in the manner of tiling, in accordance with an example of the present disclosure.

FIG. 10 is a schematic diagram illustrating a canvas used for intercepting an area picture in the manner of tiling, in accordance with an example of the present disclosure.

FIG. 11 is a schematic diagram illustrating structure of a skin editor of a client, in accordance with an example of the present disclosure.

### EMBODIMENTS OF THE INVENTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

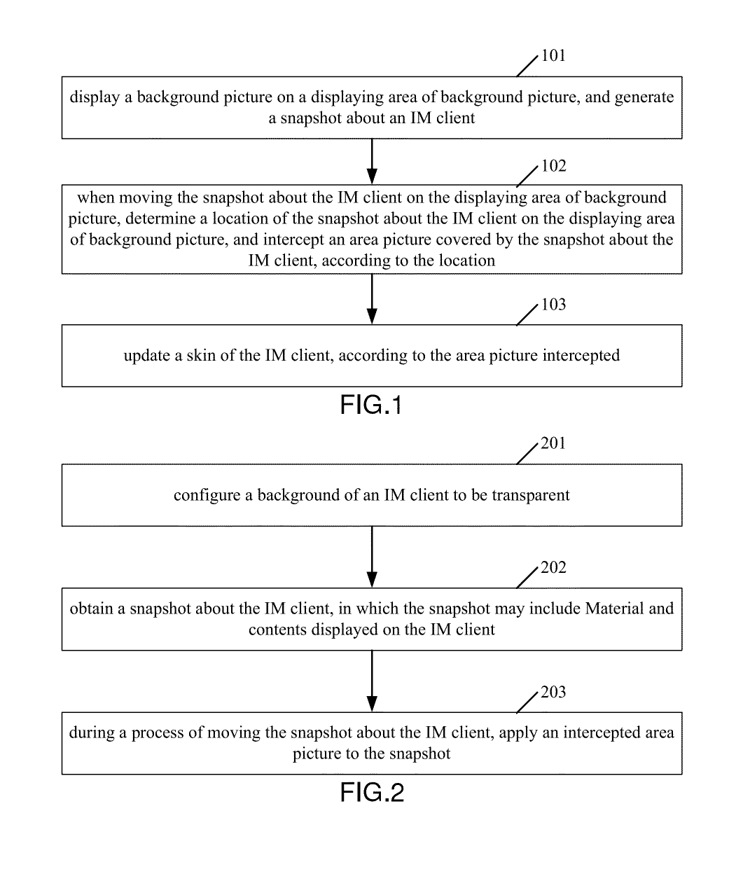

FIG. 1 is a flowchart illustrating a method for editing a skin of an IM client, in accordance with an example of the present disclosure.

As shown in FIG. 1, the method may include the following blocks.

Block 101, display a background picture on a displaying area of background picture, and generate a snapshot about an IM client.

Block 102, when moving the snapshot about the IM client on the displaying area of background picture, determine a location of the snapshot about the IM client on the displaying area of background picture, and intercept an area picture covered by the snapshot about the IM client, according to the location.

Block 103, update a skin of the IM client, according to the area picture intercepted.

By employing the method illustrated with FIG. 1, any area of a picture may be intercepted to be taken as a skin of an IM client. Subsequently, flexibility for changing a skin of an IM client may be improved.

As an implementation mode, in accordance with the technical solution of the present disclosure, it may determine whether a displaying mode is tiling or edge padding, according to size of a background picture, and display the background picture on a displaying area of background picture, according to the determined displaying mode. Generally speaking, when size of the background picture is much smaller than that of snapshot about an IM client, determine the displaying mode is tiling. When difference between size of the background picture and that of the IM client is relatively small, or size of the background picture is much larger than that of the IM client, determine the displaying mode is edge padding.

As another implementation mode, in accordance with the technical solution of the present disclosure, it may receive displaying mode information, and employ a corresponding displaying mode to display a background picture on a displaying area of background picture, according to the received displaying mode information. A user may select a displaying mode in the example.

To implement What You See Is What You Get (WYSIWYG), an example of the present disclosure may also provide a technical solution to preview a skin in real time. In the process of intercepting an area picture, perform a picture synthesis on the intercepted area picture and the snapshot about the IM client, so as to form a skin to be previewed.

An Alpha value of a picture with an Alpha channel in an IM client may be configured as 0, so as to preview a skin. Regarding the real-time skin preview, specific descriptions may be as follows.

Generally speaking, an IM client viewed by a user consists of three layers, that is, background, Material and contents displayed on the IM client. The Material may be a picture with an Alpha channel. When performing an Alpha mixture on the Material and a background picture, effects of viewing the background picture may be achieved by configuring Alpha to be 0.

FIG. 2 is a flowchart illustrating a method for previewing a skin, in accordance with an example of the present disclosure.

As shown in FIG. 2, the method may include the following blocks.

Block 201, configure a background of an IM client to be transparent.

In the block, the background of the IM client may be transparent, when configuring Alpha to be 0.

Block 202, obtain a snapshot about the IM client, at this time the snapshot may include Material and contents displayed on the IM client.

Block 203, during the process of moving the snapshot about the IM client, apply an intercepted area picture to the snapshot. At this time, the snapshot about the IM client may consist of three layers, that is, a background area picture intercepted, the Material and the contents displayed on the IM client. Thus, effects of skin preview may be achieved.

At present, modes for displaying a skin of an IM client may include edge padding and tiling. When employing the edge padding or tiling, the method illustrated with FIG. 1 may be employed to improve flexibility about skin change of an IM client.

Detailed descriptions about a skin editing method in the manner of edge padding and that in the manner of tiling are respectively provided in the following.

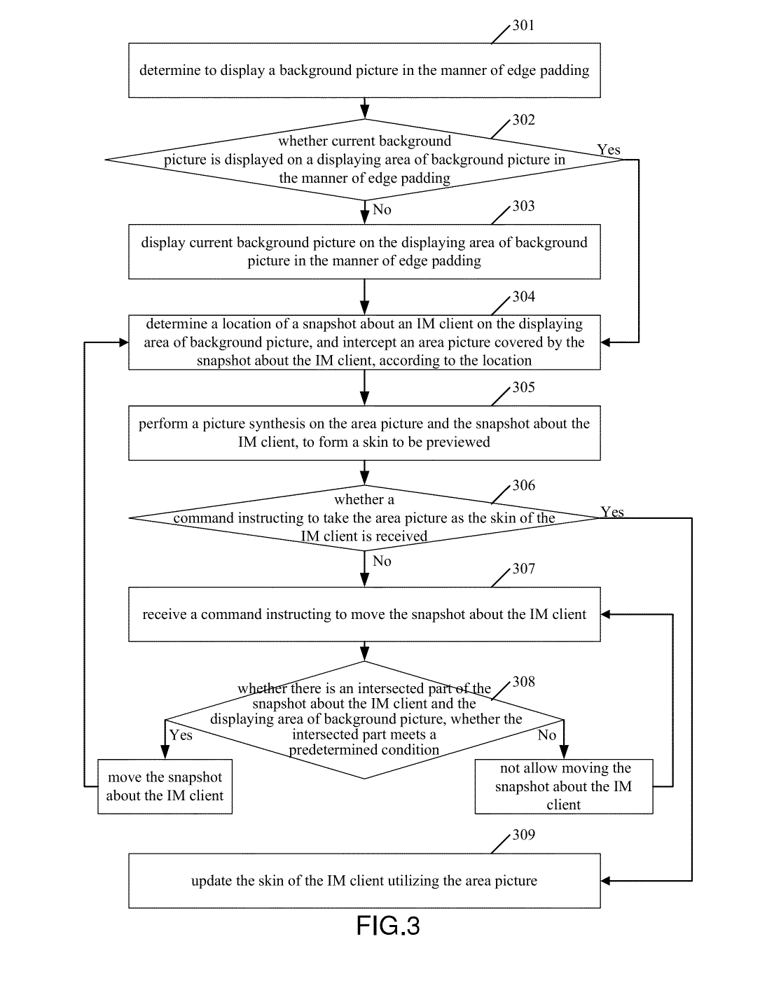

FIG. 3 is a flowchart illustrating a method for editing a skin in the manner of edge padding, in accordance with an example of the present disclosure.

As shown in FIG. 3, the method may include the following blocks.

Block 301, determine to employ an edge padding mode to display a background picture.

In the block, a user may select to employ the edge padding mode to display the background picture. Alternatively, a skin editor may automatically determine a displaying mode is the edge padding mode, according to a displaying area of background picture and size of the background picture.

Block 302, determine whether current background picture is displayed on the displaying area of background picture in the manner of edge padding; if yes, proceed with block 304; otherwise, proceed with block 303.

Block 303, display current background picture on the displaying area of background picture in the manner of edge padding.

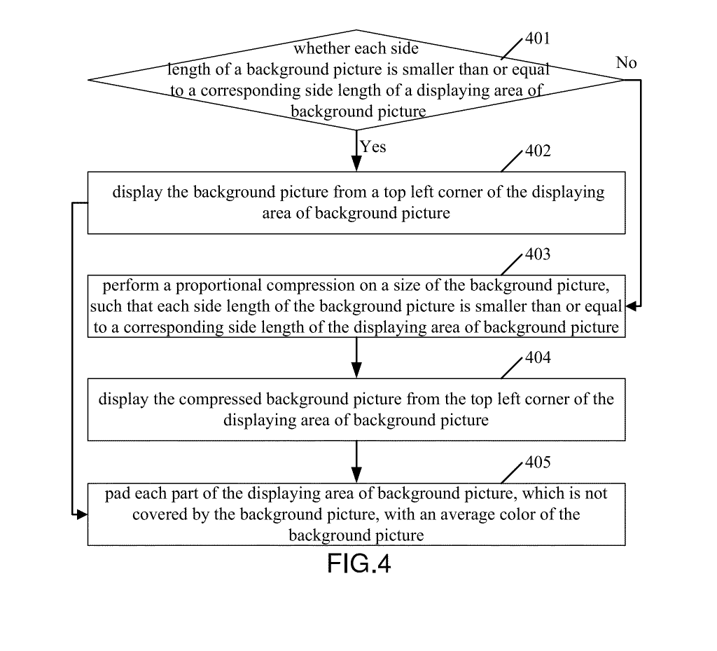

In the block, a method for displaying current background picture on the displaying area of background picture in the manner of edge padding may refer to FIG. 4 to FIG. 6.

Block 304, determine a location of a snapshot about an IM client on the displaying area of background picture, and intercept an area picture covered by the snapshot about the IM client, according to the location.

Block 305, perform a picture synthesis on the area picture and the snapshot about the IM client, to form a skin to be previewed.

Suppose a picture displaying area which may be intercepted is BkgRect, a snapshot area of an IM client is IMRect, in the block, when all the parts of IMRect are included in BkgRect, directly obtain intercepted picture contents, and utilize the picture contents to synthesize a skin to be previewed. When a part of IMRect is included in BkgRect, an intersected area of IMRect and BkgRect may employ the intercepted picture contents. Each part of IMRect moved out may be padded with an average color of the background picture. Utilize the intercepted picture contents and the average color to synthesize a skin to be previewed.

Block 306, determine whether a command instructing to take the area picture as the skin of the IM client is received; if yes, proceed with block 309; otherwise, proceed with block 307.

Block 307, receive a command instructing to move the snapshot about the IM client.

Block 308, determine whether there is a part intersected by the snapshot about the IM client and the displaying area of background picture, and whether an intersected part meets a predetermined condition. When there is the intersected part and the intersected part meets the predetermined condition, move the snapshot about the IM client according to the command received in block 307, and return to block 304. When there is no intersected part, or the intersected part doesn't meet the predetermined condition, not allow moving the snapshot about the IM client, and return to block 307, so as to continuously receive the command instructing to move the snapshot about the IM client.

In the block, generally speaking, the predetermined condition means there is a predetermined number of pixels intersected by a snapshot about an IM client and a displaying area of background picture. For example, there are at least 5 intersected pixels. A main reason for the intersected part to meet the predetermined condition is as follows. When needing to intercept a background picture, it is not allowed moving all the parts of the snapshot about the IM client out of the displaying area located by the background picture.

Block 309, utilize the area picture to update the skin of the IM client.

FIG. 4 is a flowchart illustrating a method for displaying current background picture on a displaying area of background picture in the manner of edge padding, in accordance with an example of the present disclosure.

As shown in FIG. 4, the method may include the following blocks.

Block 401, determine whether each side length of a background picture is smaller than or equal to a corresponding side length of a displaying area of background picture, if yes, proceed with block 402; otherwise, proceed with block 403.

In the block, size of the background picture BkgSize and size of the displaying area of background picture BkgShowSize may be determined in advance. When length and width of the background picture is respectively smaller than or equal to length and width of the displaying area of background picture, that is, when BkgSize.ck≦ShowSize.cx and BkgSize.cy≦BkgShowSize.cy, proceed with block 402. When BkgSize.cx>BkgShowSize.cx or BkgSize.cy>BkgShowSize.cy, proceed with block 403.

Block 402, display the background picture from a top left corner of the displaying area of background picture, and proceed with block 405.

Block 403, perform a proportional compression on the size of the background picture, such that each side length of the background picture is smaller than or equal to a corresponding side length of the displaying area of background picture.

Block 404, display the compressed background picture from the top left corner of the displaying area of background picture.

Block 405, employ an average color of the background picture to pad each part of the displaying area of background picture, which is not covered by the background picture.

After displaying current background picture on the displaying area of background picture with the method illustrated with FIG. 4, any area of the background picture may be intercepted and taken as a skin of an IM client.

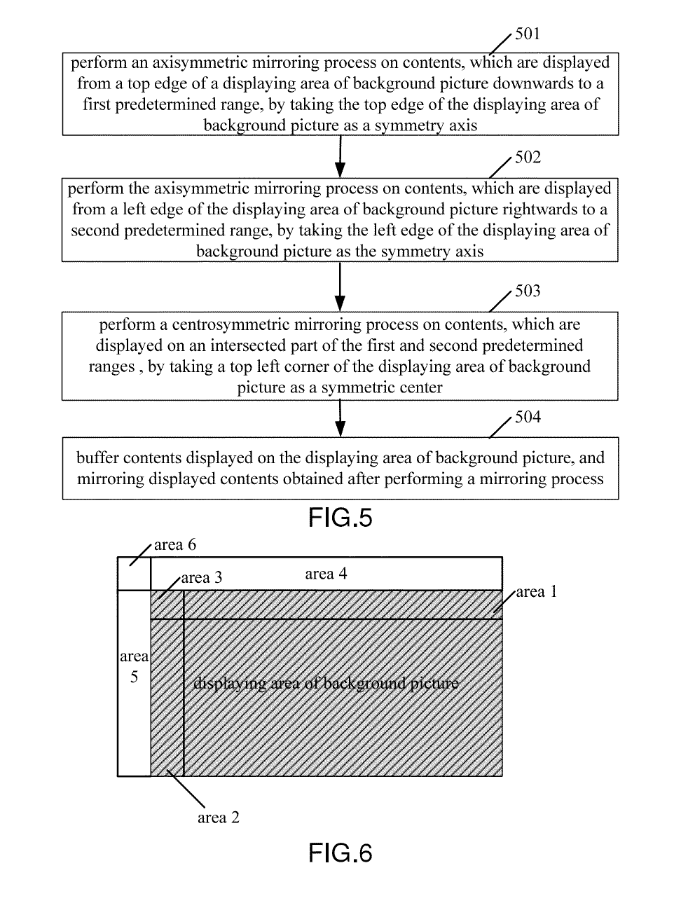

To further improve flexibility of skin change of an IM client, so as to slowly transit to a background picture, when a snapshot about an IM client is moved out of a displaying area of background picture, an example of the present disclosure may also provide a method for performing a transition process on contents displayed on the displaying area of background picture, which may refer to FIG. 5.

FIG. 5 is a flowchart illustrating a method for performing a transition process on contents displayed on a displaying area of background picture, in accordance with an example of the present disclosure.

As shown in FIG. 5, the method may include the following blocks.

Block 501, perform an axisymmetric mirroring process on contents displayed from a top edge of a displaying area of background picture downwards to a first predetermined range, by taking the top edge of the displaying area of background picture as a symmetry axis.

Block 502, perform the axisymmetric mirroring process on contents displayed from a left edge of the displaying area of background picture rightwards to a second predetermined range, by taking the left edge of the displaying area of background picture as the symmetry axis.

Block 503, perform a centrosymmetric mirroring process on contents displayed on a range intersected by the first predetermined range and the second predetermined range, by taking a top left corner of the displaying area of background picture as a symmetric center.

Sequence of blocks 501 to 503 may be changed. Blocks 501 to 503 may also be executed simultaneously.

Block 504, buffer contents displayed on the displaying area of background picture, and mirroring displayed contents obtained after performing a mirroring process.

When performing a transition process on contents displayed on a displaying area of background picture with the method illustrated with FIG. 5, the process of intercepting the area picture covered by the snapshot about the IM client in block 304 shown in FIG. 3 may include the follows.

Intercept the contents displayed on the displaying area of background picture, and displayed contents covered by the IM client in the mirroring displayed contents.

FIG. 6 is a schematic diagram illustrating a transition process performed on contents displayed on a displaying area of background picture, in accordance with an example of the present disclosure.

As shown in FIG. 6, perform an up mirroring process on contents displayed from a top edge of a displaying area of background picture downwards to a predetermined range, that is, area 1, by taking the top edge of the displaying area of background picture as a symmetry axis, and obtain contents displayed on area 4. Perform a left mirroring process on contents displayed from a left edge of the displaying area of background picture rightwards to a predetermined range, that is, area 2, by taking the left edge of the displaying area of background picture as the symmetry axis, and obtain contents displayed on area 5. An intersected part of area 1 and area 2 is area 3. Perform a mirroring process on contents displayed on area 3, by taking a top left corner of the displaying area of background picture as a symmetric center, and obtain the contents displayed on area 6.

Based on a result of transition process illustrated with FIG. 6, when employing the method illustrated with FIG. 3 to intercept an area picture, the displaying area of background picture shown in FIG. 6 as well as contents displayed on area 4, area 5 and area 6 may be intercepted.

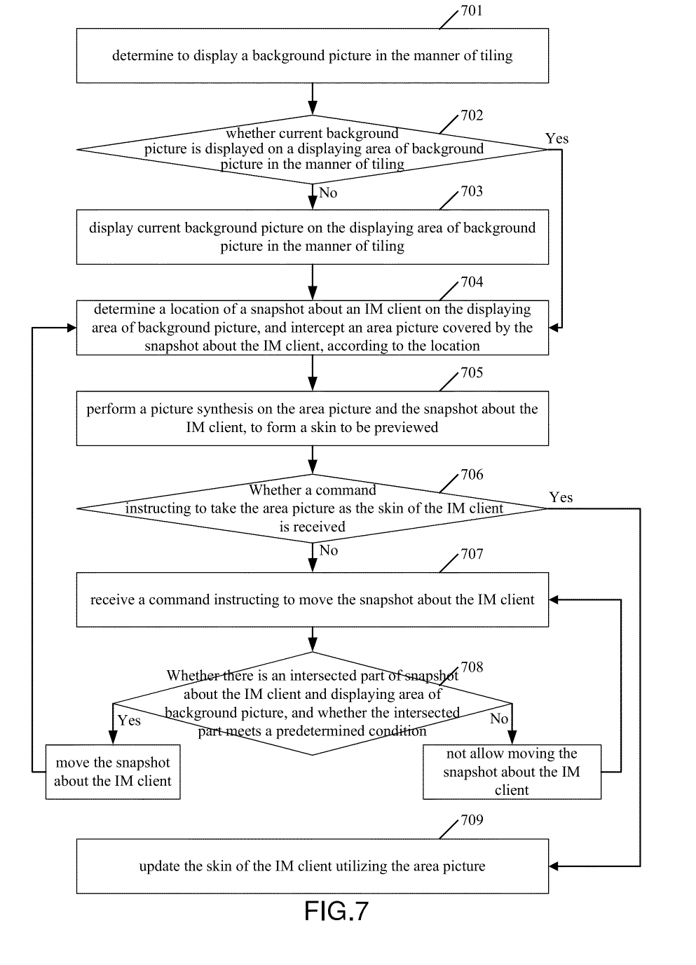

FIG. 7 is a flowchart illustrating a method for editing a skin in the manner of tiling, in accordance with an example of the present disclosure.

As shown in FIG. 7, the method may include the following blocks.

Block 701, determine to employ a tiling mode to display a background picture.

In the block, a user may select to employ the tiling mode to display the background picture. Alternatively, a skin editor may automatically determine that a displaying mode is the tiling mode, according to size of a displaying area of background picture and size of the background picture.

Block 702, determine whether current background picture is displayed on the displaying area of background picture in the manner of tiling, if yes, proceed with block 704; otherwise, proceed with block 703.

Block 703, display current background picture on the displaying area of background picture in the manner of tiling.

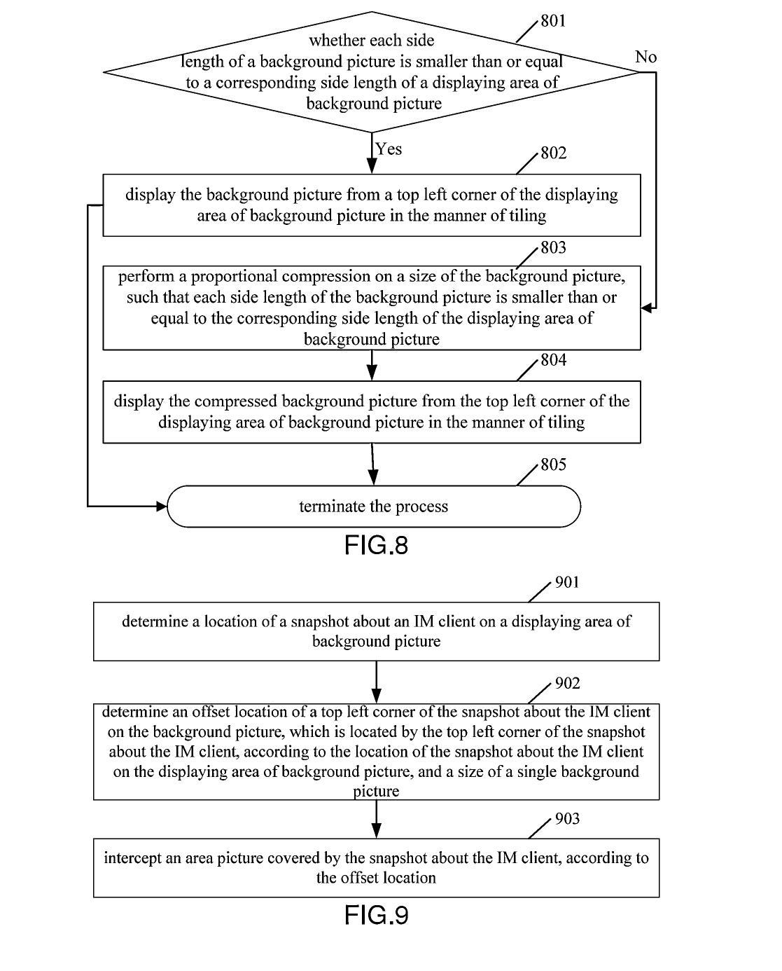

In the block, a method for displaying current background picture on the displaying area of background picture in the manner of tiling may refer to FIG. 8.

Block 704, determine a location of a snapshot about an IM client on the displaying area of background picture, and intercept an area picture covered by the snapshot about the IM client, according to the location.

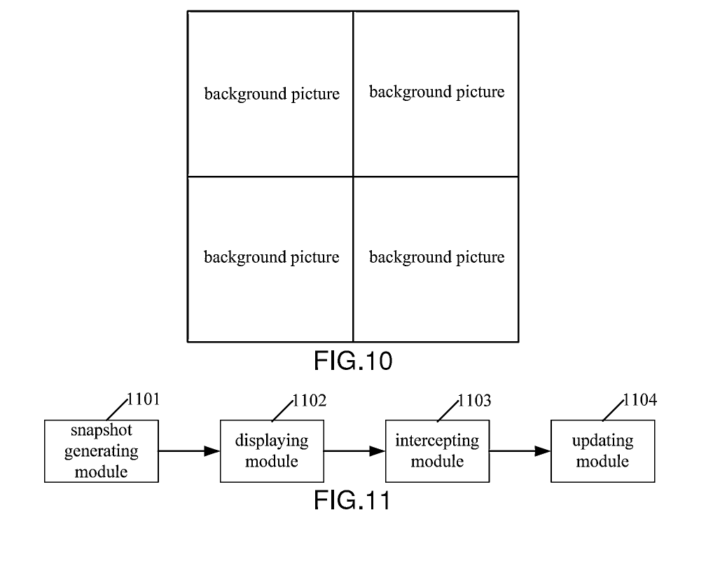

The specific implementation method about the block may refer to FIG. 9 and FIG. 10.

Block 705, perform a picture synthesis on the area picture and the snapshot about the IM client, to form a skin to be previewed.

In the block, display the intercepted area picture on a snapshot area of the IM client in the manner of tiling, so as to form the skin to be previewed.

Block 706, determine whether a command instructing to take the area picture as the skin of the IM client is received; if yes, proceed with block 709; otherwise, proceed with block 707.

Block 707, receive a command instructing to move the snapshot about the IM client.

Block 708, determine whether there is an intersected part of the snapshot about the IM client and the displaying area of background picture, and whether the intersected part meets a predetermined condition. When there is an intersected part and the intersected part meets the predetermined condition, receive the command instructing to move the snapshot about the IM client according to block 707, and return to block 704. When there is no intersected part, or the intersected part doesn't meet the predetermined condition, not allow moving the snapshot about the IM client, and return back to block 707 to continuously receive the command instructing to move the snapshot about the IM client.

The block is the same as block 308.

Block 709, utilize the area picture to update the skin of the IM client.

In the block, update the skin of the IM client in the manner of tiling, by employing the intercepted area picture.

FIG. 8 is a flowchart illustrating a method for displaying current background picture on a displaying area of background picture in the manner of tiling, in accordance with an example of the present disclosure.

As shown in FIG. 8, the method may include the following blocks.

Block 801, determine whether each side length of a background picture is smaller than or equal to a corresponding side length of a displaying area of background picture; if yes, proceed with block 802; otherwise, proceed with block 803.

In the block, size of the background picture BkgSize and size of the displaying area of background picture BkgShowSize may be determined in advance. When length and width of the background picture is respectively smaller than or equal to length and width of the displaying area of background picture, that is, when BkgSize.ck≦ShowSize.cx and BkgSize.cy≦BkgShowSize.cy, proceed with block 802. When BkgSize.cx>BkgShowSize.cx or BkgSize.cy>BkgShowSize.cy, proceed with block 803.

Block 802, display the background picture from a top left corner of the displaying area of background picture in the manner of tiling, and terminate the process.

Block 803, perform a proportional compression on the size of the background picture, such that each side length of the background picture may be smaller than or equal to a corresponding side length of the displaying area of background picture.

Block 804, display the compressed background picture from the top left corner of the displaying area of background picture in the manner of tiling, and terminate the process.

FIG. 9 is a flowchart illustrating a method for intercepting an area picture in the manner of tiling, in accordance with an example of the present disclosure.

As shown in FIG. 9, the method may include the following blocks.

Block 901, determine a location of a snapshot about an IM client on a displaying area of background picture.

Block 902, determine an offset location of a top left corner of the snapshot about the IM client on the background picture, which is located by the top left corner of the snapshot about the IM client, according to the location of the snapshot about the IM client on the displaying area of background picture, and size of a single background picture.

In the block, suppose the displaying area of background picture is BkgRect, a snapshot area of the IM client is IMRect, and an area to be intercepted is ClipRect. “.left” may indicate a left border of a corresponding area. “.Width” may indicate a width of a corresponding area. “.right” may indicate a right edge of a corresponding area. “.top” may indicate a top edge of a corresponding edge. “.Height” may indicate a height of a corresponding area. “.bottom” may indicate a bottom edge of a corresponding area. The method for determining the offset location may include the follows.

When BkgRect.left<=IMRect.left, ClipRect.left=(IMRect.left−BkgRect.left) Bkg.Width, and ClipRect.right=ClipRect.left+Bkg.Width.

When BkgRect.left>IMRect.left, ClipRect.left=(IMRect.left−BkgRect.left) % Bkg.Width+Bkg.Width, and ClipRect.right=ClipRect.left+Bkg.Width.

When BkgRect.top<=IMRect.top, ClipRect.top=(IMRect.top−BkgRect.top) Bkg.Height, and ClipRect.bottom=ClipRect.top+Bkg.Height.

When BkgRect.top>IMRect.top, ClipRect.top=(IMRect.top−BkgRect.top) % Bkg.Height+Bkg.Height, and ClipRect.bottom=ClipRect.top+Bkg.Height.

Symbol “%” may indicate a modulo operation.

Block 903, intercept an area picture covered by the snapshot about the IM client, according to the offset location.

In the block, the offset location may be taken as the top left corner of the area picture to be intercepted. Intercept the area picture from the contents displayed on the displaying area of background picture, according to size of a single background picture. To facilitate interception, a canvas may be generated in advance, and the area picture may be intercepted from the canvas, which may refer to FIG. 10.

FIG. 10 is a schematic diagram illustrating a canvas used for intercepting an area picture in the manner of tiling, in accordance with an example of the present disclosure.

As shown in FIG. 10, 4 background pictures are tiled on a canvas in the manner of two rows and two columns.

First of all, determine a location of a top left corner of a snapshot about an IM client on a displaying area of background picture, and determine an offset location of the top left corner of the snapshot about the IM client on a background picture, which is located by the top left corner of the snapshot about the IM client, according to the offset location.

Subsequently, take the offset location of a background picture, which is located on the first row and first column of the canvas shown in FIG. 10, as the top left corner of the area picture to be intercepted. Intercept the area picture from the canvas, according to size of a single background picture.

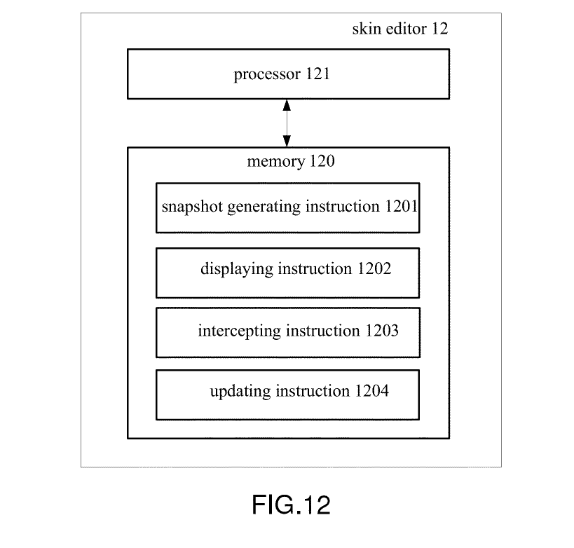

FIG. 11 is a schematic diagram illustrating structure of a skin editor of an IM client, in accordance with an example of the present disclosure.

As shown in FIG. 11, the skin editor may include a snapshot generating module 1101, a displaying module 1102, an intercepting module 1103 and an updating module 1104.

The snapshot generating module 1101 is configured to generate a snapshot about an IM client.

The displaying module 1102 is configured to display the snapshot about the IM client, and display a background picture on a displaying area of background picture.

The intercepting module 1103 is configured to determine a location of the snapshot about the IM client on the displaying area of background picture, when the snapshot about the IM client is moved on the displaying area of background picture, and is further configured to intercept an area picture covered by the snapshot about the IM client, according to the location.

The updating module 1104 is configured to update a skin of the IM client, according to the intercepted area picture.

The displaying module 1102 is further configured to determine whether a displaying mode is tiling or edge padding, according to the size of the background picture, or, receive information about the displaying mode, and display the background picture on the displaying area of background picture, according to the determined displaying mode or the received information about the displaying mode.

When the displaying mode is edge padding, and each side length of the background picture is smaller than or equal to a corresponding side length of the displaying area of background picture, the displaying module 1102 is further configured to display the background picture from a top left corner of the displaying area of background picture. When one side length of the background picture is larger than a corresponding side length of the displaying area of background picture, the displaying module 1102 may firstly perform a proportional compression on the size of the background picture, such that each side length of the background picture may be smaller than or equal to a corresponding side length of the displaying area of background picture. Subsequently, the displaying module 1102 may display the compressed background picture from the top left corner of the displaying area of background picture, and pad each part of the displaying area of background picture, which is not covered by the background picture, with an average color of the background picture.

The displaying module 1102 may include a mirroring module and a buffering module.

The mirroring module is configured to perform an axisymmetric mirroring process on contents, which are displayed from a top edge of the displaying area of background picture downwards to a first predetermined range, by taking the top edge of the displaying area of background picture as a symmetry axis. The mirroring module is further configured to perform the axisymmetric mirroring process on contents, which are displayed from a left edge of the displaying area of background picture rightwards to a second predetermined range, by taking the left edge of the displaying area of background picture as the symmetric axis. The mirroring module is further configured to perform a centrosymmetric mirroring process on contents, which are displayed on an intersected part of the first and second predetermined ranges, by taking the top left corner of the displaying area of background picture as a symmetric center.

The buffering module is configured to buffer the contents displayed on the displaying area of background picture, and mirroring displayed contents obtained after performing a mirroring process.

Correspondingly, the intercepting module 1103 may be configured to intercept the contents displayed on the displaying area of background picture, and displayed contents not covered by the IM client included in the mirroring displayed contents.

When the displaying mode is tiling, the displaying module 1102 may display the background picture from the top left corner of the displaying area of background picture, in the manner of tiling.

When the displaying mode is tiling, the intercepting module 1103 may determine an offset location of the top left corner of the snapshot about the IM client on a background picture, which is located by the top left corner of the snapshot about the IM client, according to the location of the snapshot about the IM client on the displaying area of background picture and size of a single background picture, and intercept the area picture covered by the snapshot about the IM client, according to the offset location.

When the displaying mode is tiling, the intercepting module 1103 is configured to generate a canvas, in which 4 background pictures are tiled on the canvas in the manner of two rows and two columns, take an offset location of a background picture located on the first row and first column as the top left corner of the area picture to be intercepted, and intercept the area picture from the canvas, according to the size of the single background picture.

The updating module 1104 is configured to update the skin of the IM client in the manner of tiling, by utilizing the area picture intercepted from the canvas.

The foregoing skin editor may also include a previewing module.

The previewing module is configured to set an Alpha value of a picture with an Alpha channel in the IM client to be 0, and perform a picture synthesis on the area picture and the snapshot about the IM client, so as to form a skin to be previewed.

The foregoing skin editing method of an IM client and skin editor, which are provided by examples of the present disclosure, may be applied to skin change of an IM client and another client.

Thus, it can be seen that by employing the skin editing method and skin editor provided by examples of the present disclosure, when a user has selected a displaying mode or the skin editor has automatically determined the displaying mode, location of an area picture to be intercepted may be selected by moving a client snapshot. Subsequently, the skin editor may intercept an area picture corresponding to the background picture, and synthesize the intercepted area picture and client snapshot, to generate the skin to be previewed. After the user has selected a favorite skin, that is, after receiving a command from the user instructing to take the area picture as the client skin, apply the intercepted area picture to the client to change the skin, such that the flexibility of skin change about a client may be greatly improved.

An example of the present disclosure also provides a machine readable storage medium, which may store instructions about the method for editing a client skin executable by a machine. Specifically speaking, a system or device with the storage medium may be provided. The storage medium may store software program codes to implement a function of any foregoing example. A computer (or a Central Processing Unit (CPU) or a Mini Processing Unit (MPU)) of the system or device may read and execute the program codes stored in the storage medium.

Under the circumstances, the program codes read from the storage medium may implement a function of any foregoing example. Thus, the program codes and the storage medium storing the program codes may form a part of the present disclosure.

The storage medium providing the program codes may include a soft disk, a fixed disk, a magnetooptical disk, a Compact Disk (CD) (such as CD-Read-Only Memory (CD-ROM), CD-Recordable (CD-R), CD-ReWritable (CD-RW), Digital Video Disc-ROM (DVD-ROM), DVD-Random Access Memory (DVD-RAM), DVD-RW, DVD+RW), a magnetic tape, a non-volatile memory card and an ROM. Alternatively, the program codes may be downloaded from a server computer via a communication network.

In addition, it should be noted that, a part of or all of the actual operations may be completed by executing the program codes read by a computer, or may be completed by an Operating System (OS) based on instructions of the program codes. Thus, a function of any foregoing example may be implemented.

In addition, it should be understood that, write the program codes read from the storage medium into a memory, which is set in an expansion broad inserted into a computer. Alternatively, write the program codes read from the storage medium to a memory, which is set in an expansion unit connecting with a computer. Subsequently, enable a CPU installed in the expansion board or an expansion unit to execute a part of or all of the actual operations, based on the instructions of the program codes. Thus, a function of any foregoing example may be implemented.

The foregoing is preferred examples of the present disclosure, which is not used for limiting the protection scope of the present disclosure. Any modifications, equivalent substitutions and improvements made within the spirit and principle of the present disclosure, should be covered by the protection scope of the present disclosure.

1. A method for editing a skin of a client, comprising:
displaying a background picture on a displaying area of background picture;
generating a client snapshot;
when moving the client snapshot on the displaying area of background picture, determining a location of the client snapshot on the displaying area of background picture, intercepting an area picture covered by the client snapshot according to the location; and
updating the skin of the client according to the intercepted area picture.

2. The method according to claim 1, wherein displaying the background picture on the displaying area of background picture comprises:
determining whether a displaying mode is tiling or edge padding, according to a size of the background picture; or
receiving information about the displaying mode; and
displaying the background picture on the displaying area of background picture, according to the determined displaying mode or the received information about the displaying mode.

3. The method according to claim 2, wherein when the displaying mode is the edge padding, displaying the background picture comprises:
when each side length of the background picture is smaller than or equal to a corresponding side length of the displaying area of background picture, displaying the background picture from a top left corner of the displaying area of background picture;
when one side length of the background picture is larger than a corresponding side length of the displaying area of background picture, performing a proportional compression on the size of the background picture, such that the each side length of the background picture is smaller than or equal to the corresponding side length of the displaying area of background picture, and displaying the compressed background picture from the top left corner of the displaying area of background picture; and
padding each part of the displaying area of background picture, which is not covered by the background picture, with an average color of the background picture.

4. The method according to claim 2, wherein when the displaying mode is the edging padding, displaying the background picture comprises:
performing an axisymmetric mirroring process on contents displayed from a top edge of the displaying area of background picture downwards to a first predetermined range, by taking the top edge of the displaying area of background picture as a symmetry axis;
performing the axisymmetric mirroring process on contents displayed from a left edge of the displaying area of background picture rightwards to a second predetermined range, by taking the left edge of the displaying area of background picture as the symmetry axis;
performing a centrosymmetric mirroring process on contents displayed on an intersected part of the first and second predetermined ranges, by taking the top left corner of the displaying area of background picture as a symmetric center;
buffering contents displayed on the displaying area of background picture, and mirroring displayed contents obtained after performing a mirroring process;
wherein intercepting the area picture covered by the client snapshot comprises:
intercepting the contents displayed on the displaying area of background picture, and displayed contents, which are included in the mirroring displayed contents and covered by the client

5. The method according to claim 2, wherein when the displaying mode is the tiling, displaying the background picture comprises:
displaying the background picture from the top left corner of the displaying area of background picture, in the manner of the tiling;
wherein intercepting the area picture covered by the client snapshot comprises:
determining an offset location of the top left corner of the client snapshot on the background picture, which is located by the top left corner of the client snapshot, according to the location of the client snapshot on the displaying area of background picture, and a size of a single background picture, and intercepting the area picture covered by the client snapshot, according to the offset location.

6. The method according to claim 5, wherein intercepting the area picture covered by the client snapshot according to the offset location comprises:
generating a canvas in advance, wherein 4 background pictures are tiled on the canvas in the manner of two rows and two columns;
taking the offset location, which is located on the first row and first column of the background picture, as the top left corner of the area picture to be intercepted; and
intercepting the area picture from the canvas, according to the size of the single background picture;
wherein updating the skin of the client utilizing the intercepted area picture comprises:
updating the skin of the client in the manner of the tiling, by utilizing the area picture intercepted from the canvas.

7. The method according to claim 1, further comprising:
during a process of moving the client snapshot, determining whether there is a predetermined number of pixels overlapped by the client snapshot and the displaying area of background picture;
when determining there is a predetermined number of pixels overlapped by the client snapshot and the displaying area of background picture, allowing moving the client snapshot;
when determining there is no predetermined number of pixel overlapped by the client snapshot and the displaying area of background picture, forbidding moving the client snapshot.

8. The method according to claim 1, wherein updating the skin of the client according to the intercepted area picture comprises:
performing a picture synthesis on the area picture and the client snapshot, to form the skin to be previewed;
when receiving a command instructing to take the area picture as the skin of the client, utilizing the area picture to update the skin of the client.

9. The method according to claim 8, wherein performing the picture synthesis on the area picture and the client snapshot, so as to form the skin to be previewed comprises:
configuring an Alpha value of a picture with an Alpha channel in the client to be 0.

10. A skin editor of a client, comprising a snapshot generating module, a displaying module, an intercepting module and an updating module; wherein
the snapshot generating module is configured to generate a client snapshot;
the displaying module is configured to display the client snapshot, and display a background picture on a displaying area of background picture;
the intercepting module is configured to determine a location of the client snapshot on the displaying area of background picture, when the client snapshot is moved on the displaying area of background picture, and intercept an area picture covered by the client snapshot, according to the location; and
the updating module is configured to update a skin of the client, according to the intercepted area picture.

11. The skin editor according to claim 10, wherein the displaying module is further configured to determine whether a displaying mode is tiling or edge padding, according to a size of the background picture, or, receive information about the displaying mode, and display the background picture on the displaying area of background picture, according to the determined displaying mode or the received information about the displaying mode.

12. The skin editor according to claim 11, wherein
when the displaying mode is the edge padding, and each side length of the background picture is smaller than or equal to a corresponding side length of the displaying area of background picture, the displaying module is further configured to display the background picture from a top left corner of the displaying area of background picture;
when one side length of the background picture is larger than a corresponding side length of the displaying area of background picture, the displaying module is further configured to perform a proportional compression on the size of the background picture, such that the each side length of the background picture is smaller than or equal to the corresponding side length of the displaying area of background picture, and the displaying module is further configured to display the compressed background picture from the top left corner of the displaying area of background picture, and pad each part of the displaying area of background picture, which is not covered by the background picture, with an average color of the background picture.

13. The skin editor according to claim 11, wherein the displaying module comprises a mirroring module and a buffering module,
the mirroring module is configured to perform an axisymmetric mirroring process on contents, which are displayed from a top edge of the displaying area of background picture downwards to a first predetermined range, by taking the top edge of the displaying area of background picture as a symmetry axis;
the mirroring module is further configured to perform the axisymmetric mirroring process on contents, which are displayed from a left edge of the displaying area of background picture rightwards to a second predetermined range, by taking the left edge of the displaying area of background picture as the symmetry axis;
the mirroring module is further configured to perform a centrosymmetric mirroring process on contents, which are displayed on an intersected part of the first and second predetermined ranges, by taking the top left corner of the displaying area of background picture as a symmetric center;
the buffering module is configured to buffer contents displayed on the displaying area of background picture, and mirroring displayed contents obtained after performing a mirroring process; and
the intercepting module is further configured to intercept the contents displayed on the displaying area of background picture, and displayed contents, which are included in the mirroring displayed contents and covered by the client.

14. The skin editor according to claim 11, wherein
when the displaying mode is the tiling, the displaying module is further configured to display the background picture from a top left corner of the displaying area of background picture, in the manner of the tiling;
when the displaying mode is the tiling, the intercepting module is further configured to determine an offset location of the top left corner of the client snapshot on the background picture, which is located by the top left corner of the client snapshot, according to the location of the client snapshot on the displaying area of background picture, and a size of a single background picture, and intercept the area picture covered by the client snapshot according to the offset location.

15. The skin editor according to claim 14, wherein
when the displaying mode is the tiling, the intercepting module is further configured to generate a canvas, wherein 4 background pictures are tiled on the canvas in the manner of two rows and two columns, take an offset location, which is located on the first row and first column of the background picture, as the top left corner of the area picture to be intercepted, and intercept the area picture from the canvas, according to the size of the single background picture; and
the updating module is further configured to update the skin of the client in the manner of the tiling, by utilizing the area picture intercepted from the canvas.

16. The skin editor according to claim 10, wherein the skin editor may further include a previewing module,
the previewing module is configured to set an Alpha value of a picture with an Alpha channel in the client to be 0, perform a picture synthesis on the area picture and the client snapshot, to from the skin to be previewed.
